(19) United States
(12) Patent Application Publication
(10) Pub. No.: US 2018/0014912 A1
(43) Pub. Date: Jan. 18, 2018

(54) REINFORCING SPLINT FOR ORAL APPLIANCE

(71) Applicant: Achaemenid, LLC, Stratford, CT (US)

(72) Inventor: Reza Radmand, Brookline, MA (US)

(73) Assignee: Achaemenid, LLC, Stratford, CT (US)

(21) Appl. No.: 15/650,219

(22) Filed: Jul. 14, 2017

Related U.S. Application Data
(60) Provisional application No. 62/362,758, filed on Jul. 15, 2016.

(51) Int. Cl. A61C 5/00; A61C 8/00

(52) U.S. Cl. CPC A61C 5/007; A61C 8/0016; A61C 5/90; A61C 8/0077

(57) ABSTRACT

An oral appliance includes a reinforcing member or splint embedded within a polymer shell. The reinforcing member or splint includes an anterior portion embedded within an anterior wall of the polymeric shell, a posterior portion embedded within a posterior wall of the polymeric shell, and a transverse portion embedded within a transverse plate of the polymeric shell. The reinforcing member or splint is operative for preventing movement of the user's dentition over time when wearing the oral appliance.

### CROSS-REFERENCE TO RELATED APPLICATIONS

This application claims the benefit of U.S. Provisional Application No. 62/362,758 filed Jul. 15, 2016, which is incorporated herein by reference in its entirety.

### FIELD

This application is generally directed to oral appliances, for example, oral appliances used in the treatment of a medical or dental condition. More particularly, this application is directed to a reinforcing member or splint for use with an oral appliance to assist with preventing movement of the user's teeth over time.

### BACKGROUND

Oral appliances are often worn by a user in connection with the treatment of a medical or dental condition, for example, sleep apnea. Oral appliances are often configured (i.e., shaped) to secure the oral appliance in the oral cavity relative to the upper and/or lower teeth (“dentition”) of the user. For example, an oral appliance may include a bite plate or surface that faces the occlusal surface (i.e., bite surface) of the upper and/or lower dentition. During sleep, the user may have a tendency to urge the upper and lower jaw into a closed position against the bite plate, which then exerts a pressure against the dentition. As a result, wearing an oral appliance may cause the teeth to shift from their original position over time. Specifically, it has been observed that the lower anterior teeth may tend to flare outwards and the upper anterior teeth may tend to flare inwards. There is also evidence that the spacing between molars and canines may change, and that the curve of spee may flatten (i.e., such the natural curvature of the teeth in both arches is diminished or lost). Accordingly, there is a need to provide a means of preventing the movement of dentition when using oral appliances.

### BRIEF DESCRIPTION

In one aspect, the present disclosure is directed generally to a reinforcing member or splint for being integrally incorporated into an oral appliance, such as those used in the treatment of various medical or dental conditions. The reinforcing member or splint may generally be configured to extend from the front (i.e., anterior or buccal) face of the dentition to the back (i.e., posterior or lingual) face of the dentition, so that the dentition of the wearer is stabilized and maintained in its original position (i.e., at the time of initiating use). The splint may have a solid construction or an at least partially open (e.g. porous) construction. The splint may find utility for use with a variety of oral appliances including, but not limited to oral appliances used in the treatment of sleep apnea.

In another aspect, an oral appliance may generally include a polymeric shell or body shaped to receive at least a portion of the user's dentition. A reinforcing member or splint may be at least partially encapsulated or embedded within the polymeric shell or body. All or a portion of the splint and/or encapsulating shell may be shaped to conform to the surfaces of the user's dentition. The splint is operative for providing structural support and stability to the dentition so that the teeth of the wearer are less prone to movement over time when using the oral appliance.

### BRIEF DESCRIPTION OF THE DRAWINGS

A more particular description will be rendered by reference to specific embodiments thereof that are illustrated in the appended drawings. Understanding that these drawings depict only typical embodiments thereof and are not therefore to be considered to be limiting of its scope, exemplary embodiments will be described and explained with additional specificity and detail through the use of the accompanying drawings in which:

FIG. 1A is a schematic, perspective view of a reinforcing member or splint, according to one aspect of the disclosure;

FIG. 1B is a schematic, top plan view of the reinforcing member or splint of FIG. 1A;

FIG. 1C is a schematic, cross-sectional view of the reinforcing member or splint of FIG. 1A, taken along a line 1C-1C, and showing only the cross-section in isolation;

FIG. 1D is a schematic, cross-sectional view of the reinforcing member or splint of FIG. 1A, viewed along 1D-1D, and showing only the end in isolation;

FIG. 1E is a schematic rear elevation view of the reinforcing member or splint of FIG. 1A;

FIG. 1F is a schematic side elevation view of the reinforcing member or splint of FIG. 1A;

FIG. 2 is a schematic, partial cross-sectional view of an oral appliance including the reinforcing member or splint of FIG. 1A, being worn by a user, according to another aspect of the disclosure;

FIG. 3 depicts an alternate embodiment of a reinforcing member or splint, according to one aspect of the disclosure, with a mold of a user's dentition; and

FIG. 4 schematically illustrates an exemplary aperture pattern that may be used in accordance with the disclosure.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DETAILED DESCRIPTION

Reference will now be made in detail to various exemplary embodiments. Each example is provided by way of explanation, and is not meant as a limitation or constitute a definition of all possible embodiments.

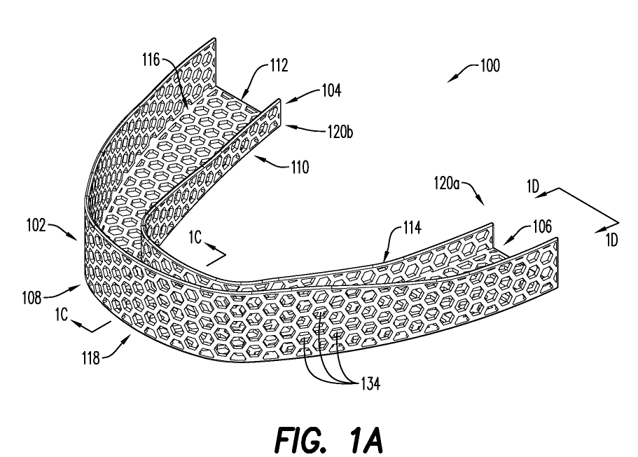

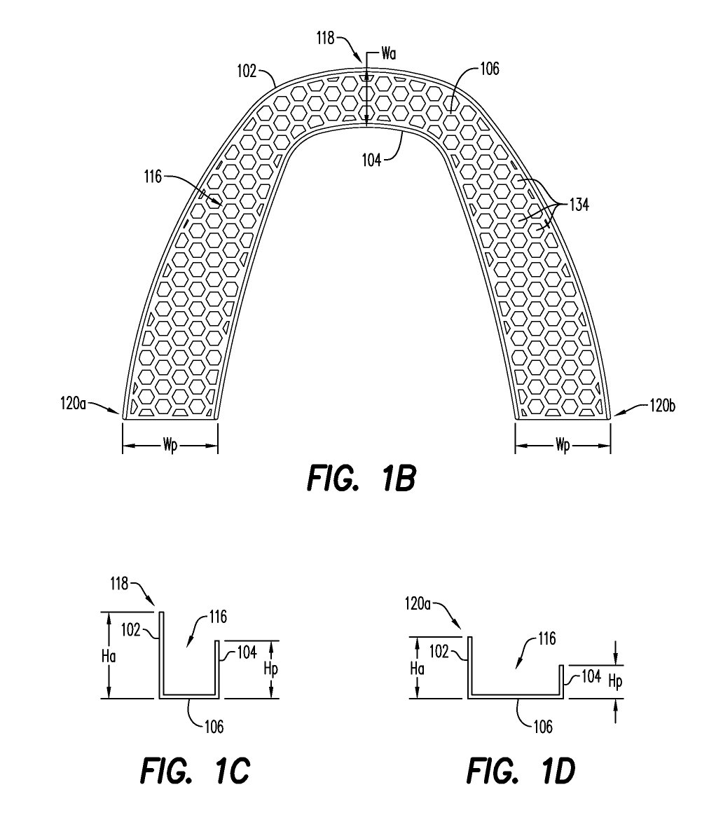

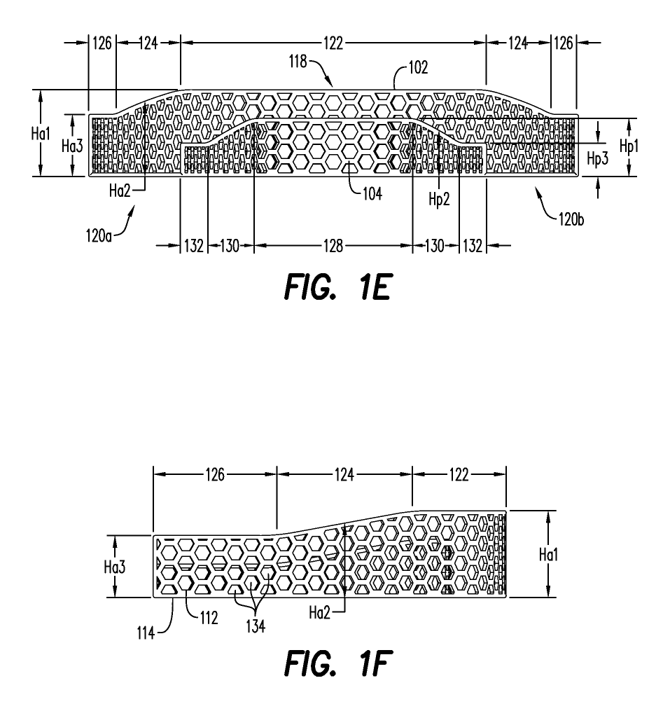

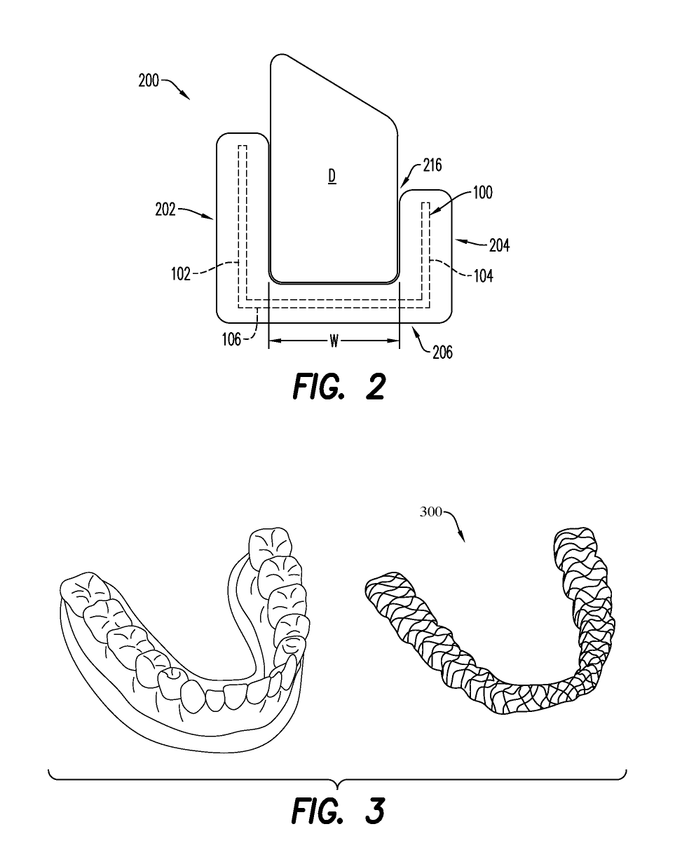

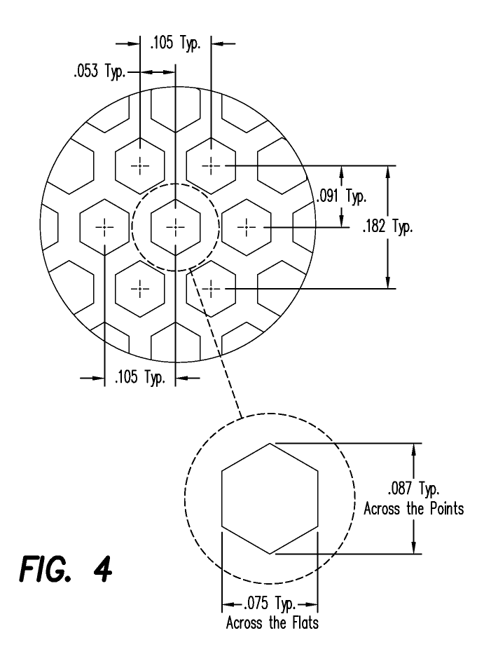

FIGS. 1A-1F schematically illustrate an exemplary oral appliance splint or retaining member 100 according to the disclosure. As will be discussed in connection with FIG. 2, the splint may be incorporated into an oral appliance 200 to assist with preventing the movement of dentition of a user, so that the dentition is maintained in an initial or original position.

As shown in FIG. 1A, the splint 100 generally comprises a semi-rigid or rigid frame or structure shaped to include an anterior portion (or wall) 102, a posterior portion (or wall) 104, and a transverse portion (or base/wall) 106 that generally extends between and joins the anterior portion 102 and the posterior portion 104.

The anterior portion 102, posterior portion 104, and transverse portion 106 of the splint 100 are generally contiguous with one another and may be integral parts of a unitary structure or body. Accordingly, it may be difficult to define precise boundaries between adjacent portions. Nonetheless, for purposes of explanation, and not limitation, such portions 102, 104, 106 may be described or characterized as being as individual portions of the splint 100 that may be joined to one another along their respective boundaries and/or peripheral margins. Thus, for example, the anterior portion 102 of the splint 100 may be joined to the transverse portion 106 of the splint 100 along an anterior boundary region 108, and the transverse portion 106 of the splint 100 may be joined to the posterior portion 104 of the splint 100 along a posterior boundary region 110. In some embodiments, the anterior boundary region 108 and posterior boundary region 110 may have a more distinct, angular shape (for example, as shown in FIGS. 1A-1F). In other embodiments, the anterior boundary region 108 and posterior boundary region 110 may have a somewhat curved shape to provide a smooth transition between the adjacent portions of the splint 100 (for example, as shown in FIG. 3, discussed below). The anterior portion 102, posterior portion 104, and transverse portion 106 are collectively bounded by a peripheral margin 112 of the splint 100 and a peripheral (i.e., outermost) edge 114 of the splint 100.

As best seen in FIGS. 1A and 1B, the anterior portion 102, posterior portion 104, and transverse portion 106 of the splint 100 are configured to define a channel 116. The anterior portion 102 and the posterior portion 104 of the splint 100 may each have a generally curved or arcuate (i.e., arched or horseshoe) shape when viewed in top or bottom plan view (FIG. 1B), with the transverse portion 106 extending therebetween, such the channel 116 likewise has a generally curved or arcuate (i.e., arched or horseshoe) shape when viewed in top or bottom plan view (FIG. 1B).

The splint 100 may generally be shaped and dimensioned to receive the dentition of a user. More particularly, and as will be discussed further below, the anterior portion 102 of the splint 100 may generally be shaped and dimensioned to be positioned and/or extend along the buccal side of the dentition (i.e., between the teeth and cheeks of the user), the posterior portion 104 may generally be shaped and dimensioned to be positioned and/or extend along the lingual side of the dentition (i.e., between the teeth and tongue of the user), and the transverse portion or plate 106 may generally be shaped and dimensioned to be positioned and/or extend along and across the occlusal surface of the dentition (i.e., across the bite surface of the teeth of the user). Accordingly, the anterior portion 102, posterior portion 104, and transverse portion 106 of the splint 100 may respectively be referred to as the buccal portion (or wall) 102, lingual portion (or wall) 104, and occlusal portion (or base/wall) 106 of the splint 100.

The channel 116 has a width generally corresponding to a width of the transverse portion 106 of the splint 100. The width of the transverse portion 106 of the splint 100, and therefore the channel 116, may vary along the when measured at various points along transverse portion 106 of the splint 100. For example, the channel 116 may have a first width Wₐ measured at or along an apex (i.e., anteriormost point) 118 of the splint 10, and a second width Wₚ measured at or along the lateral ends (i.e., posteriormost points) 120a, 120b of the splint 100, and a plurality of other widths therebetween. In this example, the width of the channel 116 generally decreases from each lateral end 120a, 120b of the splint 100 towards the apex 118. Additionally, the channel 116 is depicted as being substantially symmetrical in width along a line 1C-1C (FIG. 1A) drawn through the apex 118. However, other possibilities are contemplated.

Additionally, as shown in FIGS. 1C and 1D, which respectively schematically illustrate a cross-sectional and an end view (both in isolation) of the splint 100, the anterior/buccal portion 102 and the posterior/lingual portion 104 of the splint 100 may generally be characterized as having a substantially upright, opposed configuration with respective heights Hₐ, Hₚ (relative to the transverse portion 106 of the splint 100 extending therebetween), so that the splint 100 has a generally U-shape or J-shape (or backwards J-shape) when viewed in cross-section.

As best seen in FIGS. 1A, 1C, and 1E, the respective heights Hₐ, Hₚ may vary, depending on the specific needs of the application. For example, the respective heights Hₐ, Hₚ of the anterior/buccal portion 102 and posterior/lingual portion 104 of the splint 100 may each generally be dimensioned so that, when part of an oral appliance, the respective heights Hₐ, Hₚ are each about one-half of a height of the dentition (as measured from the gumline towards the bite edge or surface of the teeth). In some embodiments, the posterior/lingual portion 104 may have a height Hₚ that is less than the height Hₐ of the anterior/buccal portion 102, as shown schematically in the illustrated example. In other embodiments, the respective heights Hₐ, Hₚ may be approximately equal to one another.

Additionally, the respective heights Hₐ, Hₚ may vary along the length (i.e., arc length) of the respective anterior/buccal portion 102 and posterior/lingual portion 104 of the splint 100. For example, as best seen in FIGS. 1E and 1F, the height Hₐ₁ of the anterior portion 102 of the splint 100 may be substantially constant along a first, central portion 122 of the anterior portion/wall 102 (centered along the apex 118), which may generally correspond to the front or anterior teeth of the wearer. The height Hₐ₂ of the anterior portion 102 may decrease along a second, medial portion 124 of the anterior portion/wall 102, which may generally correspond to the posterior teeth of the wearer. Finally, the height Hₐ₃ of the anterior portion 104 may be substantially constant along a third, lateral end portion 126 of the anterior portion/wall 102 proximate and adjacent to the lateral ends 120a, 120b of the splint 100, which may generally correspond to the location of the molars of the user. The height Hₐ may be symmetrical across a line 1C-1C (FIG. 1A) drawn through the apex, or may be asymmetrical, as needed to conform to the dentition of the wearer.

Similarly, the height Hp of the posterior portion 104 of the splint 100 may be substantially constant along a first, central portion 128 of the anterior portion/wall 104 (centered along the apex 118), which may generally correspond to the front or anterior teeth of the wearer. The height Hp of the posterior portion 104 may decrease along a second, medial portion 130 of the posterior portion/wall 104, which may generally correspond to the posterior teeth of the wearer. Finally, the height Hₚ of the posterior portion 104 may be substantially constant along a third, lateral end portion 132 of the posterior portion/wall 104 proximate and adjacent to the lateral ends 120a, 120b of the splint 100, which may generally correspond to the location of the molars of the user. As with the height Hₐ of the anterior portion 102, the height Hₚ of the posterior portion 104 of the splint 100 may be symmetrical or asymmetrical across a line 1C-1C (FIG. 1A) drawn through the apex, as needed to conform to the dentition of the wearer.

It will be appreciated that since each splint 100 may be custom made for each wearer in accordance with the various contours of the wearer's dentition, the above examples are merely illustrative of one specific example of a splint 100. For example, some users and/or applications may require additional contouring, while others may require less contouring, to adapt the splint to the shape of the user's dentition. Additionally, although only contours are shown and described in detail with respect to the anterior portion 102 and posterior portion 104 of the splint 100, the transverse portion 106 may likewise include contouring, for example, to adapt to the shape of the user's molars or other teeth (see, e.g., FIG. 3, discussed below). Thus, all of the countless configurations of precise splint shapes are contemplated hereby.

If desired, the splint 100 may include perforations or apertures 134 that may generally serve to reduce the overall mass of the splint 100, which may ultimately provide a more comfortable wearing experience for the user. For example, in the embodiment illustrated in FIGS. 1A-1F, the splint 100 is a mesh-like structure including a plurality of apertures 134 extending through the thickness of each of the anterior/buccal portion 102, the posterior/lingual portion 104, and the transverse/occlusal portion 106 of the splint 100.

The apertures 134 may be spaced from the peripheral edge 114 of the splint (i.e., so the apertures do not abut the peripheral edge of the splint), such that the peripheral margin 112 and peripheral edge 114 of the splint 100 are substantially continuous. Additionally, the apertures 134 may be positioned so that the anterior boundary region 108 and/or the posterior boundary region 110 are devoid of apertures (FIG. 1A).

In the illustrated embodiment, the apertures are configured as array of staggered hexagons (and some partial hexagons proximate to the peripheral margin 112 of the splint). However, the precise number, shape, geometry, size, spacing, arrangement, and other parameters describing the perforations or apertures 134 may vary for each application, as needed to provide the desired balance between mass, strength, rigidity, and so on.

For example, the apertures 134 may generally have any suitable geometric or non-geometric, symmetrical or asymmetrical, shape. By way of example, and not limitation, the apertures may be generally circular, square, rhomboid, or hexagonal in shape. The plurality of apertures may all be the same shape or may have various shapes. The apertures may form complete shapes or may resemble partial shapes (i.e., truncated portions of shapes), for example, partial circles or partial hexagons. Countless other possibilities are contemplated hereby.

The apertures 134 may generally have a major linear dimension (i.e., the greatest dimension measured between two points along the perimeter of the shape) of from about 0.025 inches to about 0.150 inches, for example, from about 0.040 inches to about 0.125 inches. In some particular examples, the apertures 134 may have a major linear dimension of from about 0.060 inches to about 0.100 inches, for example, from about 0.080 inches to about 0.090 inches. However, other suitable dimensions and ranges thereof are contemplated hereby. Moreover, the apertures may be uniform in size or may have various sizes, as needed to provide the desired overall properties of the splint.

The apertures may generally be spaced from an adjacent aperture a distance of from about 0.010 inches to about 0.200 inches, for example, from about 0.015 inches to about 0.100 inches. In some particular examples, the apertures may be spaced from an adjacent aperture a distance of from about 0.020 inches to about 0.050 inches, for example, from about 0.025 inches to about 0.040 inches. However, other suitable distances and ranges thereof are contemplated hereby.

Overall, the percent open area (i.e., the percentage of aperture area relative to the total area of the splint defined by the peripheral edge) may be from about 20% to about 80%, for example, from about 30% to about 70%. In some particular examples, the percent open area may be from about 40% to about 65%, for example, from about 45% to about 60%. In still other particular examples, the percent open area may be from about 50% to about 55%. However, other suitable percent open areas and ranges thereof are encompassed hereby.

The specific arrangement of apertures may vary, and in some embodiments, the apertures may be arranged in a linear or tiled configuration/array, a staggered configuration/array, a non-standard configuration, or in any other suitable pattern or arrangement. A linear aperture pattern may generally include rows of apertures that follow the same alignment in each row. A staggered aperture pattern may include repeated patterns of apertures having an offset alignment or angle from an adjacent row, and are specified based on an angle measured between centers of successive lines of apertures (commonly referred to as the offset angle). For example, an aperture pattern using an offset angle of greater than 0° and less than 90°, for example, 30°, 45°, or 60°, or any other number of degrees. A non-standard aperture pattern may include non-repeating patterns and/or random groups of apertures, while other areas may remain unapertured (i.e., continuous). Thus, although the apertures are shown as being staggered in the illustrated embodiment, other possibilities are contemplated hereby.

The splint may be formed from any suitable material that provides the desired balance of mass, strength, and suitability for use in an oral appliance. For example, in some embodiments, the splint may be formed from a metallic material (e.g., a metal or other weldable material), porcelain, or any combination thereof. For example, the splint may be formed from a stable biocompatible rigid metal alloy, such as those typically used in the fabrication of other dental appliances.

The splint may have a mass of less than about 30 g, for example, less than about 20 g. In some particular embodiments, the splint may have a mass of from about 5 g to about 17 g, for example, about 16 g.

The thickness of the splint 100 (i.e, the thickness of each of the anterior portion/wall 102, posterior portion/wall 104, and transverse portion (plate/base) 106 may vary for each application, and throughout each portion of the splint 100. For example, in some embodiments, the thickness of the various portions of the splint may be up to about 4 mm in thickness, for example, from about 0.5 mm to about 3 mm in thickness, for example, from about 0.8 mm to about 1.5 mm, for example, about 1 mm to about 1.25 mm in thickness.

The splint 100 may be incorporated into countless different oral appliances and/or devices that may be used in connection with the treatment of medical and/or dental conditions including, but not limited to, sleep apnea. Specifically, the splint 100 may find particular use as a reinforcing element in oral appliances and/or devices that include a mouthpiece or tray that receives the dentition of the wearer. As stated above, it has been discovered that prolonged use of such appliances or devices may result in movement of the dentition over time. However, it has been discovered that by incorporating the present reinforcing element into such an appliance or device, the dentition may be stabilized, so that little or no movement of the dentition occurs. As the patient utilizes the appliance, the embodied customized splint will maintain the integrity of the original or natural position of the dentition, even during long-term use of the oral appliance.

By way of example, and not limitation, FIG. 2 illustrates a schematic, partial cross-sectional view of exemplary oral appliance 200 including a reinforcing element or splint 100 according to the present disclosure. As will be understood by those of skill in the art, the oral appliance 200 may generally comprise a molded mouthpiece or tray (not shown) shaped to receive dentition of a user (i.e., a wearer). In the illustrated example, the oral appliance is for receiving only the upper dentition D. However, in other examples, the oral appliance may be for receiving the lower dentition, or for receiving both the lower and upper dentition. For example, the appliance may be a unitary structure or multicomponent system for receiving both the upper and lower dentition. Additionally, it will be understood that the oral appliance may be designed to be fitted over only a portion of the wearer's dentition (e.g., a partial appliance). Accordingly, numerous other possible configurations of the oral appliance are contemplated hereby. It will be appreciated that the splint can be readily adapted or modified, as needed to accommodate the shape of such other appliances.

Still viewing FIG. 2, the oral appliance 200 generally comprises a body or shell, typically formed from a polymer, and shaped to define an anterior wall 202, a posterior wall 204 opposite the anterior wall 102, and a transverse portion or plate 206 extending between and joining the anterior wall 202 and the posterior wall 202. As described in connection with the splint 100 above, the anterior wall 202, posterior wall 204, and transverse plate 206 of the appliance 200 are generally contiguous with one another and may be integral parts of a unitary structure or body; therefore, it may be difficult to define precise boundaries the between adjacent parts of the appliance 200. Nonetheless, for purposes of explanation, and not limitation, such features 202, 204, 206 may be described or characterized as being as individual parts of the appliance 200 that may be joined to one another along their respective boundaries and/or peripheral margins.

The anterior wall 202, posterior wall 204, and transverse plate 206 of the oral appliance 200 generally define a cavity or channel 216 for receiving the dentition D of the wearer. More particularly, the anterior wall 202 and the posterior wall 204 of the appliance 200 may generally be characterized as having a substantially upright, opposed configuration, with the transverse wall 206 extending therebetween, so that the appliance 200 has a generally U-shape or J-shape (or backwards J-shape) when viewed in cross-section. Additionally, similar to that shown in FIGS. 1A-1F, the anterior wall 202 and the posterior wall 204 of the appliance 200 may each have a generally curved or arcuate (i.e., arched or horseshoe) shape when viewed in top or bottom plan view, with the transverse portion 206 extending therebetween, such the channel 216 likewise has a generally curved or arcuate (i.e., arched or horseshoe) shape when viewed in top or bottom plan view.

As shown in FIG. 2, the splint 100 (shown in dashed lines) may be embedded entirely within (i.e., completely surrounded by or encapsulated within) the body or shell of the appliance, such that the anterior/buccal portion 102 of the splint 100 is embedded within the anterior wall 202 of the polymeric shell, the posterior/lingual portion 104 of the splint 100 is embedded within the posterior wall 204 of the polymeric shell, and the transverse/occlusal portion 106 of the splint 100 is embedded within the transverse plate 206 of the polymeric shell. Accordingly, the anterior wall 202 of the appliance 200 includes the anterior/buccal portion 102 of the splint 100 (and the surrounding shell), the posterior wall 204 of the appliance 200 includes posterior/lingual portion 104 of the splint 100 (and the surrounding shell), and the transverse plate 206 of the appliance 200 includes the transverse/occlusal portion 106 of the splint 100 (and the surrounding shell). The polymeric shell may also extend into the apertures of the splint, where included, to impart greater structural strength and stability to the oral appliance.

When worn by a user, the anterior wall 102 of the appliance 200 may be shaped and dimensioned to be positioned and/or extend along a buccal side of the dentition (and therefore may be referred to as a buccal wall), the posterior wall 204 of the appliance 200 may be shaped and dimensioned to be positioned and/or extend along a lingual side of the dentition (and therefore may be referred to as a lingual wall), and the transverse plate 206 may be shaped and dimensioned to be positioned and/or extend along and across an occlusal surface of the dentition (and therefore may be referred to as a occlusal wall). In this example, the splint 100 is dimensioned so that the anterior portion 102 and posterior portion 104 of the splint 102 extend upwardly about to one-half of the height of the adjacent surface of the dentition. However, other possibilities are contemplated, as discussed above.

The channel 216 has a width W generally corresponding to a width of the transverse plate 206 of the appliance 200. The width of the transverse plate 206 of the appliance 200, and therefore the channel 216, may vary along the when measured at various points along transverse plate 206 of the appliance 200, similar to that described above in connection with FIGS. 1A-1F. For example, the channel 216 may have a first width measured at the apex (i.e., anterior most point) of the appliance 200, a second width measured at the lateral ends (i.e., posterior most points) of the appliance 200, and a plurality of widths therebetween. Similarly, the height of the various walls of the appliance may vary, similar to that described above in connection with FIGS. 1A-1F.

The splint or retaining member 100 is operative for restricting or preventing movement of the dentition when the oral appliance 200 is worn by the user, for example, during treatment of a medical condition such as sleep apnea. Specifically, the splint or retaining member 100 assists with preventing back and forth movement of the teeth (buccal to lingual and lingual to buccal), and maintaining the natural curvature of the teeth (curve of spee or smile curve) over time, for example, for a period of up to 7 to 11 years.

Since the oral appliance is molded and conformed to the dentition of the user, the oral appliance may be capable of being at least temporarily secured in position when worn. As such, the oral appliance may be maintained in place during the user's sleep, particularly in situations where the user may make slight to moderate movements during sleep and/or when the user may be awake.

The oral appliance may be formed in any suitable manner. Both the shell of the oral appliance and the splint may be customized to conform to the dentition of each particular user. For example, the polymeric shell may be formed using self-conforming materials that are adaptable to changes in mouth structure, or through use of a dental impression of the individual user's dentition. To do so according to one exemplary method, an impression of the dentition may be taken. A dental impression is a negative imprint of hard (teeth) and soft tissues in the individual user's mouth from which positive reproduction (or cast) can be formed. A mold of the dentition may then be formed as is well known in the art. Using this mold, the technician may construct a customized splint to accommodate both the dentition of the user and the type of oral appliance being used. Alternatively, other techniques may be used, such as computer modeling and/or three dimensional printing.

By way of example, FIG. 3 illustrates another reinforcing member or splint 300 according to other aspects of the disclosure. In this example, a mold of the dentition has been taken (FIG. 3, left), as described above. To form the splint 300, a plurality of strips of weldable material, for example, metal, are cross-laid with one another over the mold of the dentition and bonded (using heat, soldering, or otherwise) to form a lattice-like structure or frame. In this manner, the frame is entirely customized to accommodate the shape of the user's dentition. As can be seen in FIG. 3, both the posterior portion and the occlusal portion of the splint are contoured to substantially conform to the shape of the user's molars. When embedded in an oral appliance (not shown), the corresponding portions of the polymeric shell of the oral appliance may likewise be contoured to provide a conforming fit around the user's dentition. It is noted that in the exemplary embodiment shown in FIG. 3, the lattice-like frame has a more open construction with generally diamond-shaped openings, and lacks a substantially continuous peripheral edge (as compared with the embodiment of FIGS. 1A-1F). However, a continuous peripheral edge may be added if desired.

### EXAMPLE

FIG. 3 schematically illustrates an aperture pattern for a splint, for example, a splint similar to the splint shown in FIGS. 1A-1F. The pattern comprises a staggered arrangement of uniformly sized hexagonal apertures having the various dimensions, spacing, and other parameters (all dimensions shown are in inches): major linear dimension (dimension between opposed points of hexagons)=0.087 inches; minor linear dimension (dimension between opposed flats of hexagons)=0.075 inches; spacing between apertures=0.030 inches; horizontal pitch=0.105 inches; vertical pitch=0.091 inches; and second row offset=0.053 inches.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

While the apparatus and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an,” and “the” include plural referents unless the context clearly dictates otherwise. Furthermore, references to “one embodiment,” “some embodiments,” “an embodiment,” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. An oral appliance comprising:
a polymeric shell comprising
an anterior wall,
a posterior wall opposite the anterior wall, and
a transverse plate extending between the anterior wall and the posterior wall, wherein the anterior wall, the posterior wall, and the transverse plate collectively define a channel for receiving dentition of a wearer; and
a rigid frame embedded within the polymeric shell, wherein the rigid frame comprises
an anterior portion embedded within the anterior wall of the polymeric shell,
a posterior portion embedded within the posterior wall of the polymeric shell, and
a transverse portion embedded within the transverse plate of the polymeric shell.

2. The oral appliance of claim 1, wherein the rigid frame further comprises a plurality of apertures extending through at least one of the anterior portion, the posterior portion, and the transverse portion of the rigid frame.

3. The oral appliance of claim 2, wherein at least some apertures of the plurality of apertures have one of a substantially hexagonal shape, a substantially rhomboid shape, and a substantially circular shape.

4. The oral appliance of claim 2, wherein the anterior portion, the posterior portion, and the transverse portion of the rigid frame each have a substantially continuous peripheral margin.

5. The oral appliance of claim 1, wherein the rigid frame comprises a substantially continuous body.

6. The oral appliance of claim 1, wherein
the anterior portion of the rigid frame has a height that is about one-half of a height of the dentition, and
the posterior portion of the rigid frame has a height that is less than the height of the anterior portion of the rigid frame.

7. The oral appliance of claim 1, wherein the rigid frame has a mass of less than about 35 g.

8. The oral appliance of claim 1, wherein the rigid frame has a mass of about 16 g and can withstand at least about 7 lb of sideways loading without deforming the rigid frame.

9. The oral appliance of claim 1, wherein the oral appliance is operative for treating sleep apnea.

10. An oral appliance comprising:
a polymeric shell shaped to receive at least a portion of at least one of the upper and lower dentition of a user, the polymeric shell including
a buccal wall,
a lingual wall opposite the buccal wall, and
an occlusal plate extending between and joining the buccal wall and the lingual wall to one another; and
a splint embedded within the polymeric shell, wherein the splint includes a
a buccal portion disposed within the buccal wall of the polymeric shell,
a lingual portion disposed within the lingual wall of the polymeric shell, and
an occlusal portion disposed within the occlusal plate, wherein the occlusal portion extends between and joins the buccal portion and the lingual portion of the splint to one another.

11. The oral appliance of claim 10, wherein at least one of the buccal portion, the lingual portion, and the occlusal portion of the splint includes an array of apertures extending therethrough.

12. The oral appliance of claim 11, wherein
the buccal portion, the lingual portion, and the occlusal portion of the splint at least partially define a peripheral margin of the splint, and
the array of apertures is spaced from the peripheral margin of the splint, such that the peripheral margin of the splint is substantially continuous.

13. The oral appliance of claim 12, wherein
the splint has a total area defined by a peripheral edge of the splint, and
the array of apertures comprises from about 30% to about 70% of the total area of the splint.

14. The oral appliance of claim 11, when at least some apertures of the array of apertures have a major linear dimension of from about 0.060 inches to about 0.100 inches.

15. The oral appliance of claim 11, wherein at least some apertures of the array of apertures are spaced a distance of from about 0.020 inches to about 0.050 inches from one another.

16. An oral appliance for the treatment of a medical condition, the oral appliance comprising:
a polymeric shell including
a buccal wall and a lingual wall opposite one another, and
an occlusal plate extending between and joining the buccal wall and the lingual wall to one another,
wherein the buccal wall, lingual wall, and occlusal plate define a channel for receiving dentition of a wearer, such that the buccal wall is for being positioned along a buccal side of the dentition, the lingual wall is for being positioned along a lingual side of the dentition, and the occlusal plate is for extending across an occlusal surface of the dentition; and
a retaining member embedded within the polymeric shell, the retaining member including a
a buccal portion embedded within the buccal wall of the polymeric shell,
a lingual portion embedded within the lingual wall of the polymeric shell, and
an occlusal portion embedded within the occlusal plate,
such that the buccal portion is for being positioned along the buccal side of the dentition, the lingual portion is for being positioned along the lingual side of the dentition, and the occlusal portion is for extending across the occlusal surface of the dentition,
wherein the retaining member is operative for restricting movement of the dentition during treatment of the medical condition.

17. The oral appliance of claim 16, wherein the retaining member comprises a mesh-like structure including a plurality of spaced apart apertures extending through each of the buccal portion, the lingual portion, and the occlusal portion of the retaining member.

18. The oral appliance of claim 17, wherein the mesh-like structure comprises a metallic material.

19. The oral appliance of claim 17, wherein
the apertures have a major linear dimension of from about 0.080 inches to about 0.090 inches, and
the apertures are spaced apart a distance of from about 0.025 inches to about 0.040 inches from one another.

20. The oral appliance of claim 17, wherein
the retaining member has a total area defined by a peripheral edge of the retaining member, and
the apertures comprise from about 30% to about 70% of the total area of the retaining member.
